(19) United States
(12) Patent Application Publication
(10) Pub. No.: US 2023/0304875 A1
(43) Pub. Date: Sep. 28, 2023

(54) FORCE MEASUREMENT

(71) Applicant: INTERLINK ELECTRONICS, INC., Irvine, CA (US)

(72) Inventors: Gene Chen, Olney, MD (US); Shengi Geng, Santa Barbara, CA (US); Declan Flannery, Los Angeles, CA (US)

(21) Appl. No.: 18/187,655

(22) Filed: Mar. 21, 2023

Related U.S. Application Data
(60) Provisional application No. 63/269,760, filed on Mar. 22, 2022.

(51) Int. Cl. G01L 5/00

(52) U.S. Cl. CPC G01L 5/0038

(57) ABSTRACT

A force sensing device may include a plate and a sensor plate. The sensor plate may be a first surface coupled to the plate and a second surface opposite the first surface. The sensor plate may also include an actuation structure coupled to the second surface and extending away from the second surface of the sensor plate. The force sensing device may further include a sensor aligned with the sensor plate such that a first force applied to the plate causes the actuation structure to directly contact and apply a second force to the sensor. The force sensing device may be used to determine a location, a magnitude, and/or an angle of the force applied on the plate.

### CROSS-REFERENCE TO RELATED APPLICATION

This application claims priority to U.S. Provisional Patent Application No. 63/269,760, filed on Mar. 22, 2022, the disclosure of which is incorporated herein by reference in its entirety.

### FIELD

The embodiments discussed herein are related to force measurements.

### BACKGROUND

A force applied to an input surface may be detected or measured by one or more sensors positioned beneath the input surface. To achieve an accurate reading, in some circumstance, the input surface may need to be flat and the force may need to be applied to a center of the input surface for an accurate reading. Alternately or additionally, a location of the force on the input surface may not be able to be determined using typical force measurement devices.

The subject matter claimed herein is not limited to embodiments that solve any disadvantages or that operate only in environments such as those described above. Rather, this background is only provided to illustrate one example technology area where some embodiments described herein may be practiced.

### SUMMARY

A force sensing device may include a plate and a sensor plate. The sensor plate may be a first surface coupled to the plate and a second surface opposite the first surface. The sensor plate may also include an actuation structure coupled to the second surface and extending away from the second surface of the sensor plate. The force sensing device may further include a sensor aligned with the sensor plate such that a first force applied to the plate causes the actuation structure to directly contact and apply a second force to the sensor.

### BRIEF DESCRIPTION OF THE DRAWINGS

Example embodiments will be described and explained with additional specificity and detail through the use of the accompanying drawings in which:

FIG. 1 illustrates an example force sensing system;

FIG. 2 illustrates an example top view of aspects of the force sensing system of FIG. 1;

FIG. 3 illustrates an example bottom view of aspects of the force sensing system of FIG. 1;

FIG. 4 illustrates a top view of an example sensor;

FIGS. 5A-5C illustrate example views of sensor plates and actuation structure configurations;

FIG. 6 illustrates an example computing device; and

FIG. 7 illustrates a flowchart of an example method to determine data values.

### DETAILED DESCRIPTION

According to one or more embodiments of the present disclosure, a force measurement system may include a plate that may be attached to a sensor plate that may be separated from sensors by the plate stand. The plate may receive a force on the top from an object and displace the plate stand so that the sensor plate interacts with the sensor. The plate stand may be designed to keep the sensor plate from being in contact with the sensor when no force is applied to the plate but should be able to be compressed with minimal force to allow the sensor plate to contact the sensor when force is applied to the plate. The sensor, which may be very thin, may be configured to measure a location of a force applied by the sensor plate and a magnitude of the force.

The plate may have one or more actuation structures that interact with the sensor. The sensors may be configured to provide information about where and how much force is applied by each actuation structure. The system may include two or more sensors. In some embodiments, more sensors may make force readings more accurate.

A computing system may be configured to obtain the sensor data from the sensors. Using the sensor data, the computing system may be configured to determine a magnitude of force applied to the plate and a location of where the force is applied.

The computing system may determine the magnitude and location of the force based on a lookup table (LUT.) The LUT may be generated by placing multiple different forces at multiple different locations on the plate and obtaining the readings from the sensor. The readings from the sensors could be matched with the readings in the LUT to determine the magnitude and location of the force. Alternatively, an algorithm may be developed to determine the magnitude and location of the force based on the sensor data.

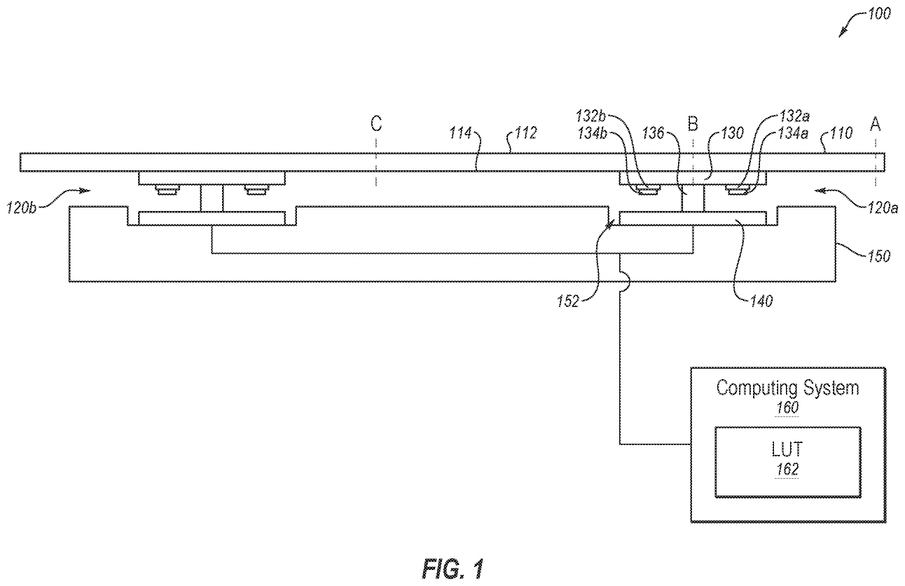

FIG. 1 illustrates a force sensing system 100, in accordance with some embodiments of the present disclosure. The force sensing system 100 may include a sensing device 102 and a computing system 160. The sensing device 102 may include a plate 110, one or more force sensing units 120, and a support 150.

In some embodiments, the plate 110 may be formed of a rigid material that is configured to have minimal flexing. For example, the plate 110 may be made of a metal, glass, or ceramic type material. Alternately or additionally, the plate 110 may be formed of a more flexible material, such as a plastic. In some embodiments, the plate 110 may include a first surface 112 and a second surface 114 opposite the first surface 112.

In some embodiments, the force sensing units 120 may be positioned between the plate 110 and the support 150. In these and other embodiments, the plate 110 may be supported by the force sensing units 120 such that the plate 110 is separated from the support 150.

In some embodiments, the force sensing units 120 may be configured to generate sensor data when a force is applied to the plate 110. For example, a force may be applied to the first surface 112 of the plate 110. The force may be applied at any angle with respect to the first surface 112 of the plate 110. For example, the force may be applied at an angle that is non-parallel to a normal of the first surface 112. Alternately or additionally, the force may be applied at any location along the first surface 112 of the plate 110. The force may be applied by any object that contacts the plate 110. For example, an object may rest on the plate 110 and the mass of the object may result in the force being applied to the plate 110. Alternately or additionally, an object may apply a force to the plate 110 that is greater or less than the force applied based on the mass of the object. For example, an appendage of a human or an object controlled by a human may apply the force to the plate 110. In these and other embodiments, a normal of the first surface 112 of the plate 110 may be parallel to a direction of gravity such that a mass of an object may apply the force to the plate 110. Alternately or additionally, the normal of the first surface 112 may be at an angle with respect to a direction of gravity. For example, the normal of the first surface 112 may be perpendicular or approximately perpendicular to a direction of gravity or a normal of a surface of the earth.

In some embodiments, the force applied to the first surface 112 may cause one or more of the force sensing units 120 to generate sensor data. The one or more of the force sensing units 120 may send the sensor data to the computing system 160.

The computing system 160 may obtain the sensor data and use the sensor data to determine a magnitude of the force applied to the plate 110. Alternately or additionally, the computing system 160 may use the sensor data to determine a location on the first surface 112 where the force is applied. Alternately or additionally, the computing system 160 may use the sensor data to determine a direction that the force is applied to the plate 110.

In some embodiments, the computing system 160 may include memory and at least one processor, which are configured to perform operations as described in this disclosure, among other operations. In some embodiments, the computing system 160 may include computer-readable instructions that are configured to be executed to perform operations described in this disclosure.

In some embodiments, the first surface 112 may have a planar profile. Alternately or additionally, the first surface 112 may have a non-planar profile. For example, the first surface 112 may have a rounded profile, such that the first surface 112 is convex or concave. Alternately or additionally, a portion of the first surface 112 may have a partially rounded profile, a frustoconical profile, a sloping profile, a graded profile, or any other type of profile that is non-planar. Alternately or additionally, the first surface 112 may have an irregular profile. For example, the first surface 112 may include one or more high and low points. In these and other embodiments, the first surface 112 may have a wave profile. Based on the profile of the first surface 112, a force applied to the first surface 112 may not be applied in a direction perpendicular to an entirety of the first surface 112 or one or more portions of the first surface 112. For example, the force may be in a direction non-parallel to a normal of the first surface 112 in a location where the first force is applied to the first surface 112.

In some embodiments, the second surface 114 may include a similar profile as the first surface 112 or may have a different profile. For example, the second surface 114 may have a planar profile and the first surface 112 may have a non-planar profile.

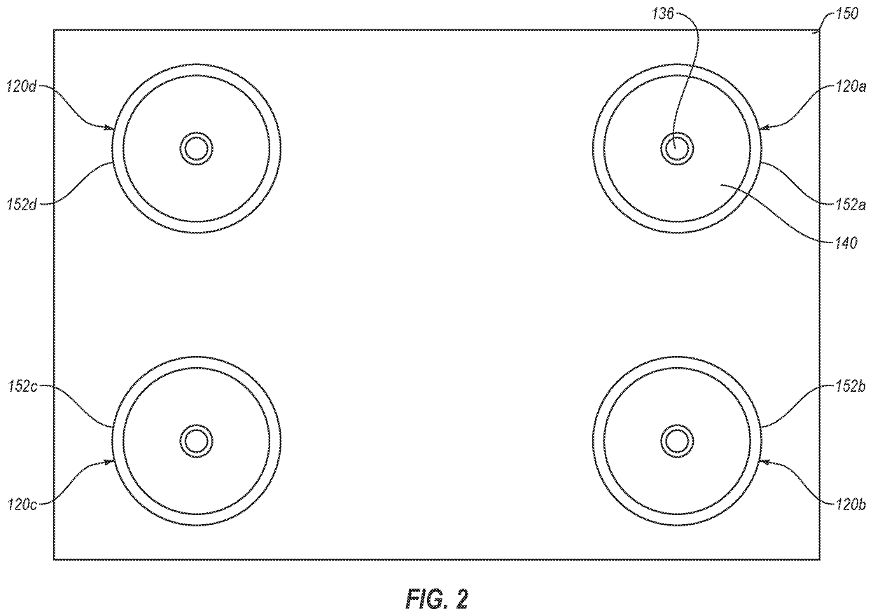

FIG. 1 illustrates a first force sensing unit 120a and a second force sensing unit 120b of the force sensing units 120. The sensing device 102 may include two or more force sensing units 120. For example, the sensing device 102 as illustrated may include four force sensing units 120 as depicted in FIG. 2. An increase in a number of the force sensing units 120 may increase a sensitive of the sensing device 102 to determine a location and/or a direction of a force applied to the first surface 112.

For ease of explanation, elements of the first force sensing unit 120a are described in this disclosure. In some embodiments, each of the force sensing units 120 in the sensing device 102 may include a similar structure. Alternately or additionally, one or more of the force sensing units 120 may have a first structure and others of the one or more of the force sensing units 120 may have a second structure that is different than the first structure.

In some embodiments, the first force sensing unit 120a may include a sensor plate 130, an actuation structure 132, a cushion 134, a plate stand 136, and a sensor 140. The sensor plate 130 may be coupled to the plate 110. For example, the sensor plate 130 may be in contact with the plate 110. The sensor 140 may be coupled to the support 150. For example, the sensor 140 may be in contact with the support 150. The plate stand 136 may extend between the sensor plate 130 and the support 150. In some embodiments, the plate stand 136 may extend through the sensor 140. For example, the sensor 140 may have an opening through which the plate stand 136 may extend. As a result, the plate stand 136 may be in contact with the sensor plate 130 and the support 150 but be separated from the sensor 140.

In some embodiments, the sensor plate 130 may be formed of the same material as the plate 110 or of a different type of material. In these and other embodiments, the sensor plate 130 may also have a similar shape as the sensor 140. Alternately or additionally, the sensor plate 130 may have a similar shape as a recess 152 in the support 150 such that the sensor plate 130 may enter the recess 152.

In some embodiments, the sensor plate 130 may include one or more actuation structures 132. For example, the sensor plate 130 may include a first actuation structure 132a and a second actuation structure 132b. In these and other embodiments, the actuation structures 132 may be formed of similar material as the sensor plate 130 and/or the plate 110.

In some embodiments, the actuation structures 132 may extend away from a surface of the sensor plate 130 toward the sensor 140. In these and other embodiments, when a top surface of the sensor 140 extends below a top surface of the support 150, the actuation structures 132 may have a height at least equal to a difference between the top surface of the sensor 140 and the top surface of the support 150. The sensor plate 130 may include any number of actuation structures 132. For example, the sensor plate 130 may include 1, 2, 3, 4, 5, 6, 7, 8, 9, 10, 12, 16, or more actuation structures. In these and other embodiments, the actuation structures 132 may have any number of different dimensions and/or shapes. For example, one or more of the actuation structures 132 may have a first shape and dimension and other of the actuation structures 132 may have a second shape and dimension. In some embodiments, the actuation structures 132 may be spaced equally apart around the surface of the sensor plate 130. Alternately or additionally, the actuation structures 132 may be spaced according to one or more patterns with equal or unequal spacing between the actuation structures 132 in the patterns. Alternately or additionally, the actuation structures 132 may be randomly distributed along the surface of the actuation structures 132. Some examples of the shape, dimension, and spacing of actuation structures are illustrated in FIGS. 5A-5C.

In some embodiments, one or more of the actuation structures 132 may include a cushion 134 coupled to the surface of the actuation structures 132 that is nearest to the sensor 140. For example, the first actuation structure 132a may include a first cushion 134a and the second actuation structure 132b may include a second cushion 134b.

The cushions 134 may be configured to contact the sensor 140 and apply a force to the sensor 140. In these and other embodiments, the cushions 134 may be formed of a flexible material that is configured to expand laterally when compressed. For example, the cushions 134 may be formed of silicone, neoprene, thermoplastic elastomers, Thermoplastic Rubber, Styrenic Block Copolymers (TPE-S), Thermoplastic Polyolefins (TPE-O or TPO), Thermoplastic vulcanisates (TPE-V or TPV), Thermoplastic polyurethanes (TPE-U or TPU), Thermoplastic copolyesters (TPE-E or COPE or TEEE), Melt processable rubber (MPR), and Thermoplastic polyether block amides (TPE-A), among other types of materials. The materials may have a Poisson's Ratio larger than 0. As a result, when the cushions 134 is pressed against the sensor 140, the cushions 134 may expand laterally and increase an amount of surface area of the cushions 134 that contacts the sensor 140. As a result, the force applied by the cushions 134 is spread out over a larger area of a surface of the sensor 140 which may assist the sensor 140 to generate more consistent sensor data for a given force. Alternately or additionally, the cushions 134 may expand unequally in lateral directions. As a result, the cushions 134 may assist to redirect the force applied to the first surface 112 of the plate 110 to be normal to the surface of the sensor 140. For example, a force may be applied at an angle with respect to the surface of the sensor 140 and the first surface 112 of the plate 110. The cushions 134 may be compressed and expand in directions to redirect the force to be more normal to the surface of the sensor 140.

In some embodiments, the plate stand 136 may be coupled between the sensor plate 130 and the sensor 140. In these and other embodiments, the plate stand 136 may be configured to support the weight of the plate 110 such that without a force being applied to the first surface 112 of the plate 110, the cushions 134 may not contact the sensor 140. The plate stand 136 may be constructed of a material that may compress to allow the cushions 134 to contact the sensor 140 when a force is applied to the first surface 112. For example, the plate stand 136 may be constructed of an elastic material or may include one or more springs. In these and other embodiments, the material for the plate stand 136 may have a coefficient of elasticity such that the plate stand 136 may support the weight of the plate 110 and the sensor plates 120 such that the cushions 134 may not contact the sensors 140 but additional force may compress the plate stand 136 such that the cushions 134 may contact the sensors 140. For example, the additional force may be a force that is 1, 10, 100, or 1000, newtons or some other force.

In some embodiments, the plate stand 136 may be configured to allow tilting of the sensor plate 130 when a force is applied to the first surface 112. As a result of the tilting, a force applied by the first cushion 134a on a first side of the sensor plate 130 may be more than a force applied by the second cushion 134b on a second side of the sensor plate 130. For example, the plate stand 136 may be configured such that a force applied at position A may result in the first cushion 134a applying more force to the sensor 140 than the second cushion 134b. As another example, the plate stand 136 may be configured such that a force applied at position B may result in the first cushion 134a applying a force to the sensor 140 equal to a force applied by the second cushion 134b. As another example, the plate stand 136 may be configured such that a force applied at position C may result in the first cushion 134a applying less force to the sensor 140 than the second cushion 134b.

In some embodiments, the sensor 140 may be any sensing device configured to generate sensor data that indicates a magnitude of force and an angle of the force on a surface of the sensor 140. For example, the sensor 140 may be a rotary member potentiometer or some other sensor type. In these and other embodiments, the sensor 140 may generate sensor data that indicates a magnitude and a location of the force applied by each of the cushions 134 to the sensor 140. For example, the sensor 140 may generate sensor data that includes a first force magnitude for a first location that corresponds to a first cushion 134a and that includes a second force magnitude for a second location that corresponds to a second cushion 134b. In these and other embodiments, the first force magnitude may be different from the second force magnitude. Thus, the sensor 140 may be configured to generate sensor data for a particular force magnitude applied by each of the cushions 134 that contact the sensor 140 when force is applied to the plate 110. In these and other embodiments, the sensor 140 may be further configured to generate an angle of the force based on the difference forces applied by each of the cushions 134. For example, a greater force applied by the first cushion 134a than the second cushion 134b may indicate the angle of force as the force is applied to the plate 110.

In some embodiments, the sensor 140 may be communicatively coupled to the computing system 160. In these and other embodiments, the sensor 140 may provide the generated sensor data to the computing system 160. In some embodiments, the sensor 140 may be electrically coupled to the computing system 160. Alternately or additionally, the sensor 140 may be wirelessly coupled to the computing system 160. In these and other embodiments, the sensor 140 may provide the sensor data to another device that may wirelessly transmit the sensor data to the computing system 160.

In some embodiments, the sensor 140 may be located in a recess 152 of the support 150. As a result, a top surface of the sensor 140 may be equal to or below a top surface of the support 150. In some embodiments, the recess 152 may be the same shape or a different shape than the sensor 140. In these and other embodiments, the recess 152 may be configured such that the recess 152 reduces lateral movement of the sensor 140.

The support 150 may be formed of a rigid material that is configured to have minimal flexing and is configured to house the sensor 140 for each of the force sensing units 120.

As discussed previously, the computing system 160 may obtain the sensor data from the sensors 140 and use the sensor data to determine one or more of: a magnitude, a location, and a direction of the force applied to the plate 110. In some embodiments, the location of the force applied to the first surface 112 of the plate 110 may be a center of gravity of an object set on the plate 110. Alternately or additionally, the location of the force applied to the first surface 112 of the plate 110 may be a center of pressure applied over an area by an object pressing against the plate 110. In some embodiments, the direction of a force applied to the first surface 112 of the plate 110 may include an angle of a force applied to the first surface 112 of the plate 110. For example, the angle may range between 1 degree and 179 degrees with an angle between 1 and 89 indicating a force from the right-hand side of the plate 110 and an angle between 179 and 91 indicating a force from the left-hand side of the plate 110. For example, it may be determined by the computing system 160 based on sensor data that a force is applied at point C, at a direction of 45 degrees, indicating that the force is coming at a 45-degree angle from the right hand side, with a magnitude of 3 newtons.

In some embodiments, the sensor data may include data from one or more of the sensors 140. In these and other embodiments, the sensor data may include a force registered by each one of the sensors 140 for each of the actuation structures 132. For example, for four sensors 140 with four actuation structures 132 associated with each sensor, the sensor data obtained by the computing system 160 may include sixteen different forces. The sensor data may, for each force, include an indication of the sensor and corresponding actuation structures that resulted in the force.

In some embodiments, the computing system 160 may be configured to determine one or more of a magnitude, a location, and a direction of a force applied to the first surface 112 of the plate 110 using the sensor data, the configuration of the force sensing units 120, and the profile of the first surface 112. For example, in some embodiments, using the configuration of the force sensing units 120 and the profile of the first surface 112, a physical model of the sensing device 102 may be determined. The physical model may represent how each of the force sensing units 120 may react to different amounts of force applied at different locations of the plate 110. In particular, the physical model may provide a correspondence between a force registered by the sensors 140 for each of the corresponding actuation structures 132 of the sensors 140 and different amounts of force applied at different locations of the plate 110 and/or at different directions. As a result, the sensor data may be applied to the physical model to determine one or more of a magnitude, a location, and a direction of a force applied to the first surface 112 of the plate 110.

In some embodiments, the computing system 160 may be configured to determine one or more of a magnitude, a location, and a direction of a force applied to the first surface 112 of the plate 110 using the sensor data and the LUT 162. In these and other embodiments, the LUT 162 may include force values for each of the forces produced by the sensors 140 for multiple different amounts of force, from multiple different directions, at multiple different locations along the first surface 112 of the plate 110. In these and other embodiments, the sensor data may be compared to data in the LUT 162. When data from the LUT 162 corresponds to the sensor data, one or more of a magnitude, a location, and a direction of a force applied to the first surface 112 of the plate 110 may be determined. In these and other embodiments, the LUT 162 may be populated by applying multiple different magnitudes of force from multiple different directions at each of multiple locations on the first surface 112 of the plate 110. For example, at a first location, twenty different magnitudes of forces may each be applied at ten different directions. For each direction and magnitude, the sensor data output by the sensors 140 may be recorded. The data in the LUT 162 may be based on the recorded sensor data.

In some embodiments, the computing system 160 may use a combination of a physical model and the LUT 162 to determine one or more of a magnitude, a location, and a direction of a force applied to the first surface 112 of the plate 110. For example, the LUT 162 may be searched first and when a corresponding entry in the LUT 162 is not discovered, the physical model may be applied.

Modifications, additions, or omissions may be made to the force sensing system 100 without departing from the scope of the present disclosure. For example in some embodiments, the force sensing units 120 may not include the cushions 134. Alternately or additionally, the force sensing units 120 may not include the actuation structures 132 and may include the cushions 134.

FIG. 2 illustrates an example top view of aspects of the force sensing system of FIG. 1, in accordance with some embodiments of the present disclosure. For example, FIG. 2 illustrates a top view of the support 150 and sensors 140 of FIG. 1. As illustrated in FIG. 2, the sensor 140, the recess 152, and the plate stand 136 may have a circular shape. In some embodiments, the plate stand 136, the sensor 140, and the recess 152 may have a different shape. For example, each of the plate stand 136, the sensor 140, and the recess 152 may have a square, rectangular, oval, trapezoidal, hexagonal, or another shape. Alternately or additionally, each of the plate stand 136, the sensor 140, and the recess 152 may have a different shape. For example, the plate stand 136 may be hexagonal, the sensor 140 may be circular, and the recess 152 may be rectangular.

FIG. 2 further illustrates the first force sensing unit 120a, the second force sensing unit 120b, a third force sensing unit 120c, and a fourth force sensing unit 120d. Each of the force sensing units 120 may be associated with one of the recesses 130a-130d. FIG. 2 illustrates four force sensing units 120 arranged in a pattern such that the four force sensing units 120 are at the vertices of a rectangle. Note that the force sensing units 120 may be arranged in different patterns. For example, the force sensing units 120 may be arranged in a triangular pattern, a hexagonal pattern, a circular pattern, a random pattern, or some other pattern. In these and other embodiments, the pattern may be based on one or more of: the type of material of the plate 110, the shape of the plate 110, the profile of the first surface 112 of the plate 110, objects that may be applying a force to the plate 110, sensitivity of the sensors 140, and a precision needed for the sensor data provided to the system 160, among other factors. Furthermore, a number of the force sensing units 120 used in the sensing device 102 may be based on similar factors as used to select the pattern for the force sensing units 120.

FIG. 2 further illustrates that the support 150 has a rectangular shape. However, the support 150 may be any shape that allows for the configuration of the recesses 130a-130d for the corresponding force sensing units 120. Modifications, additions, or omissions may be made to FIG. 2 without departing from the scope of the present disclosure.

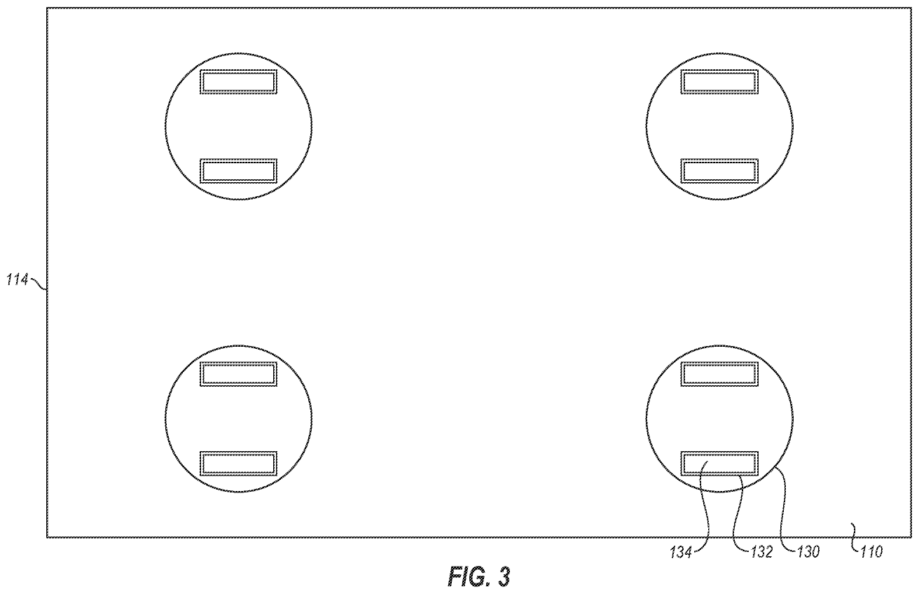

FIG. 3 illustrates an example bottom view of aspects of the force sensing system of FIG. 1, in accordance with some embodiments of the present disclosure. For example, FIG. 3 may illustrate a bottom view of the plate 110 and the sensor plates 130. As illustrated in FIG. 3, the sensor plates 130 may be attached to the second surface 114 of the plate 110. Furthermore as illustrated in FIG. 3, the sensor plates 130 may have a circular shape. In some embodiments, the sensor plates 130 may have a different shape. For example, each of the sensor plates 130 may have a square, rectangular, oval, trapezoidal, hexagonal, or another shape. Alternately or additionally, each the sensor plates 130 may have a different shape. For example, one of the sensor plates 130 may be hexagonal, another of the sensor plates 130 may be circular, and another of the sensor plates 130 may be rectangular.

In some embodiments, the shape of the sensor plates 130 may depend on a location of the sensor plates 130 within the sensing device 102. For example, a sensor plate 130 at an edge of the plate 110 may have a different shape than a sensor plate 130 near the middle of the plate 110. In some embodiments, the shape of the sensor plate 130 may match the shape of the sensor 140 or the shape of the sensor plate 130 may be different than the shape of the sensor 140.

FIG. 3 further illustrates the actuation structures 132 and the cushions 134. As illustrated, the actuation structures 132 may be rectangular and extend in a parallel direction. Other shapes of the actuation structure 132 are provided with respect to FIGS. 5A-5C. Modifications, additions, or omissions may be made to FIG. 3 without departing from the scope of the present disclosure.

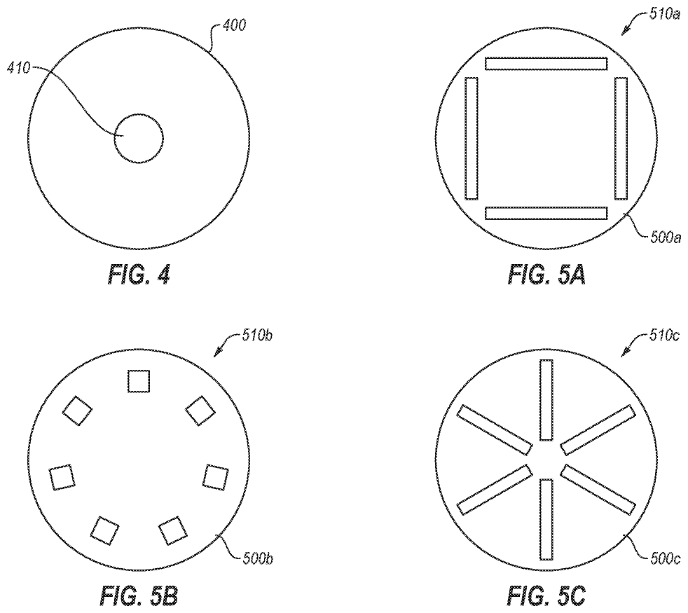

FIG. 4 illustrates a top view of an example sensor 400, in accordance with some embodiments of the present disclosure. As illustrated in FIG. 4, the sensor 400 may be circular with a circular opening 410. The opening 410 may be of sufficient dimension to allow a plate stand to pass therethrough. Alternately or additionally, the opening 410 may be of sufficient dimension to allow a plate stand to pass therethrough and to avoid contact between the plate stand and the sensor 400 when the plate stand is compressed.

In some embodiments, the sensor 400 and/or the opening 410 have a square, rectangular, oval, trapezoidal, hexagonal, or another shape. Modifications, additions, or omissions may be made to FIG. 4 without departing from the scope of the present disclosure.

FIGS. 5A-5C illustrate views of sensor plates 500 and actuation structure configurations 510, in accordance with some embodiments of the present disclosure. FIG. 5A illustrate a first sensor plate 500a and a first actuation structure configuration 510a. The first actuation structure configuration 510a may include four rectangular actuation structures arranged around the perimeter of the first sensor plate 500a in an outline of a rectangle.

FIG. 5B illustrate a second sensor plate 500b and a second actuation structure configuration 510b. The second actuation structure configuration 510b may include six square actuation structures arranged around the perimeter of the second sensor plate 500b in an outline of a circle. FIG. 5C illustrate a third sensor plate 500c and a third actuation structure configuration 510c. The third actuation structures configuration 510c may include six rectangular actuation structures arranged as spokes that extend from a central region of the third sensor plate 500c.

Modifications, additions, or omissions may be made to FIGS. 5A-5C without departing from the scope of the present disclosure. For example, other configurations and/or shapes of the actuation structures are contemplated. For example, the actuation structures may have an oval, trapezoidal, hexagonal, or another shape. In some embodiments, the shape and configuration of the actuation structures may be based on one or more of: the type of material of a plate, the shape of the plate, the profile of a surface of the plate 110, objects that may be applying a force to the plate, sensitivity of sensors, and a precision needed for the sensor data, among other factors.

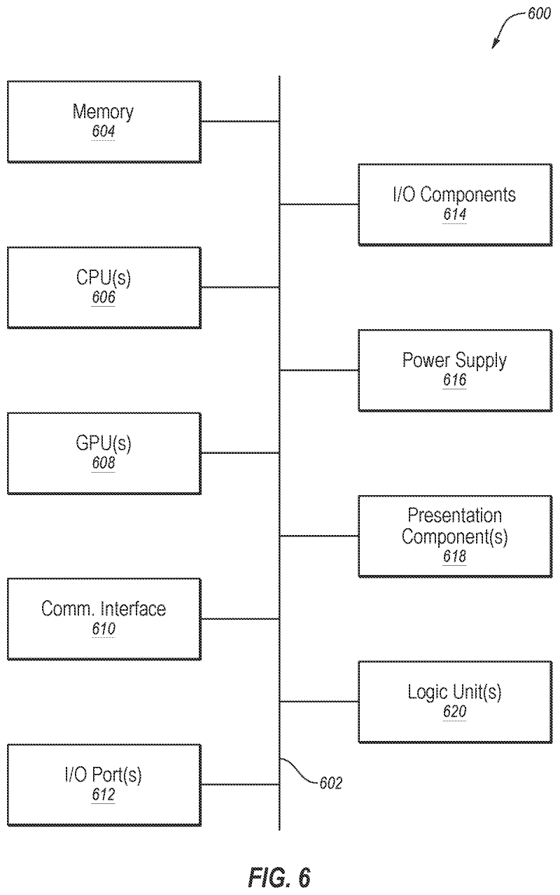

FIG. 6 is a block diagram of an example computing device(s) 600, arrange according to one or more embodiments of the disclosure. For example, the computing device 600 may be an example of the computing system 160 illustrated in FIG. 1. Computing device 600 may include an interconnect system 602 that directly or indirectly couples the following devices: memory 604, one or more central processing units (CPUs) 606, one or more graphics processing units (GPUs) 608, a communication interface 610, I/O ports 612, input/output components 614, a power supply 616, one or more presentation components 618 (e.g., display(s)), and one or more logic units 620.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “single microcontroller (MCU) board”, “embedded system”, “mobile device,” “hand-held device,” “game console,” “electronic control unit (ECU),” “virtual reality system,” “augmented reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point, connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may be an MCU for an embedded control system. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), I/O elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, including wired and/or wireless communications. The communication interface 610 may include components and functionality to enable communication over any of a number of different networks, such as USB, UART, I2C, SPI, CAN networks, or wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 612 may enable the computing device 600 to be logically coupled to other devices including the I/O components 614, the presentation component(s) 618, and/or other components, some of which may be built into (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, etc.), and output the data (e.g., as an image, video, sound, etc.).

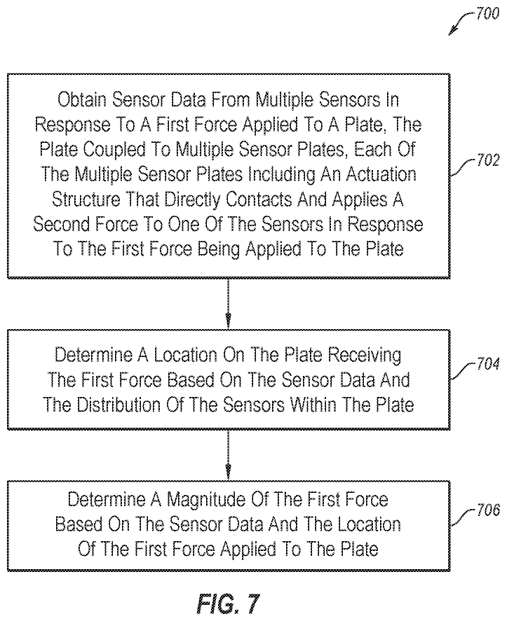

FIG. 7 illustrates a flowchart of an example method 700 to determine data values. The method 700 may be arranged in accordance with at least one embodiment described in the present disclosure. One or more operations of the method 700 may be performed, in some embodiments, by a device or system, such as the force sensing system 100 of FIG. 1 or another device or combination of devices. In these and other embodiments, the method 700 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 700 may begin at block 702, where sensor data may be obtained from multiple sensors in response to a force applied to a plate coupled to each of the sensors, such as four or more sensors 140 in the force sensing system 100. The sensor data from one of the sensors may include a magnitude of a force sensed by the sensor and/or an angle of a force sensed at the sensor.

At block 704, a location on the plate receiving the force may be determined. The location on the plate receiving the force may be determined based on magnitude of the forces applied by each of the sensors and/or an angle of the force sensed by the sensors. For example, given the differences between the forces at the different sensors, the location of force may be determined. For example, the location in a cartesian coordinate system may be determined based on the magnitude of the forces and coefficients associated with each of the sensors. The coefficients may be determined through a calibration where know forces at known locations in cartesian coordinate system are applied to the force sensing system 100 and the magnitude of the forces for each of the forces is measured. Given the known location and magnitude of the forces, the coefficients may be determined and used to determine unknown locations when a force is applied to the force sensing system 100.

At block 706, a magnitude of the force may be determined. The magnitude may be determined based on the location of the force. For example, the location of the force and the sensor output may be compared to a look-up table to determine the magnitude of the force.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A force measuring system comprising:
a plate;
a sensor plate including:
a first surface coupled to the plate;
a second surface opposite the first surface;
an actuation structure coupled to the second surface; and
a cushion coupled to the actuation structure, the actuation structure and the cushion extending away from the second surface of the sensor plate; and
a sensor aligned with the sensor plate such that a first force applied to the first surface of the plate causes the cushion to contact and apply a second force to the sensor.

2. The force measuring system of claim 1, wherein the sensor is configured to output a sensor signal in response to the sensor plate contacting and applying the second force to the sensor, the system further comprising a computing system coupled to the sensor and configured to:
receive the sensor signal, and
determine a magnitude of the first force applied to the plate based on the sensor signal.

3. The force measuring system of claim 2, wherein the computing system is further configured to determine a location on the first surface of plate where the first force is applied based on the sensor signal.

4. The force measuring system of claim 1, wherein the first force has a direction non-parallel to a normal of the first surface of the plate in a location where the first force is applied to the plate.

5. The force measuring system of claim 1, wherein a portion of the first surface of the plate has a non-planar surface profile.

6. The force measuring system of claim 1, wherein a surface profile of the first surface is different than the surface profile of the second surface.

7. The force measuring system of claim 1, further comprising:
a support configured to support the sensor; and
a plate stand coupled between the support and the sensor plate, the plate stand including material configured to compression when the first force is applied to the first surface to allow the actuation structure to directly contact the sensor.

8. The force measuring system of claim 1, wherein the sensor plate includes a plurality of actuation structures that include the actuation structure, each of the plurality of actuation structures coupled to the second surface and extending away from the second surface of the sensor plate, wherein when the first force is applied to the first surface at least one of the plurality of actuation structures directly contacts the sensor.

9. The force measuring system of claim 1, further comprising:
a plurality of sensor plates that include the sensor plate, the plurality of sensor plates include a plurality of actuation structures extending away from the plurality of sensor plates; and
a plurality of sensors that includes the sensor, each of the plurality of sensors aligned with a different one of the plurality of sensor plates such that a first force applied to the first surface of the plate causes the plurality of actuation structures to directly contact and apply a plurality of forces to the plurality of sensors.

10. A force sensing device comprising:
a plate;
a sensor plate including:
a first surface coupled to the plate;
a second surface opposite the first surface; and
an actuation structure coupled to the second surface and extending away from the second surface of the sensor plate; and
a sensor aligned with the sensor plate such that a first force applied to the plate causes the actuation structure to directly contact and apply a second force to the sensor.

11. The force sensor device of claim 10, wherein the first force has a direction non-parallel to a normal of the first surface of the plate in a location where the first force is applied to the plate.

12. The force sensor device of claim 10, wherein a portion of the first surface of the plate has a non-planar surface profile.

13. The force sensor device of claim 10, wherein a surface profile of the first surface is different than the surface profile of the second surface.

14. The force sensor device of claim 10, further comprising:
a support configured to support the sensor; and
a plate stand coupled between the support and the sensor plate, the plate stand including material configured to compression when the first force is applied to the first surface to allow the actuation structure to directly contact the sensor.

15. The force sensor device of claim 10, wherein the actuation structure includes a cushion made of a flexible material coupled between the sensor plate and the sensor, the cushion configured to directly contact the sensor.

16. The force sensor device of claim 10, wherein the sensor plate includes a plurality of actuation structures that include the actuation structure, each of the plurality of actuation structures coupled to the second surface and extending away from the second surface of the sensor plate, wherein when the first force is applied to the first surface at least one of the plurality of actuation structures directly contacts the sensor.

17. The force sensor device of claim 10, further comprising:
a plurality of sensor plates that include the sensor plate, the plurality of sensor plates include a plurality of actuation structures extending away from the plurality of sensor plates; and
a plurality of sensors that includes the sensor, each of the plurality of sensors aligned with a different one of the plurality of sensor plates such that a first force applied to the first surface of the plate causes the plurality of actuation structures to directly contact and apply a plurality of forces to the plurality of sensors.

18. A method to determine a force, the method comprising:
obtaining sensor data from a plurality of sensors in response to a first force applied to a plate, the plate coupled to a plurality of sensor plates, each of the plurality of sensor plates including an actuation structure that directly contacts and applies a second force to one of the sensors in response to the first force being applied to the plate;
determining a location on the plate receiving the first force based on the sensor data and the distribution of the sensors within the plate; and
determining a magnitude of the first force based on the sensor data and the location of the first force applied to the plate.

19. The method of claim 18, wherein a direction of the first force is applied at a non-parallel angle with respect to a normal of the first surface of the plate.

20. The method of claim 19, further comprising obtaining coefficients associated with the distribution of the sensors within the plate; wherein the location on the plate receiving the first force is determined based on the coefficients and force magnitudes from the sensor data from each of the plurality of sensors.
